(19) United States
(12) Patent Application Publication
(10) Pub. No.: US 2026/0161362 A1
(43) Pub. Date: Jun. 11, 2026

(54) AUTOMATED DEPLOYMENT OF INTEGRATED APPLICATIONS

(71) Applicant: SAP SE, Walldorf (DE)

(72) Inventors: Mayank Gupta, Karwi (IN); Umesh K, Bangalore (IN); Shubhanshu Bhadouria, Gwalior (IN); Malemnganba Mutum, Manipur (IN); Srinivasa Raghavan V, Chennai (IN); Gokula Krishnan Srinivasan, Bangalore (IN)

(21) Appl. No.: 18/975,775

(22) Filed: Dec. 10, 2024

(51) Int. Cl. G06F 8/20; G06F 8/60

(52) U.S. Cl. CPC G06F 8/20; G06F 8/60

(57) ABSTRACT

The solution enables secure, compliant, and easy deployment of integrated applications to customer infrastructure by leveraging its existing security features in unison. A deployment orchestrator provides a user interface that may be embedded in a host application. Using the user interface, a customer administrator generates a role. The deployment orchestrator provides a role template for the role. The role template identifies the permissions needed for the deployment. The customer create a role that includes those permissions and no others. The role template may be dynamically generated and include an expiration time that is based on the time of generation. Using the role, a deployment orchestrator automatically deploys the customer application to the customer infrastructure. An integration module of the deployment orchestrator sets up integration of the host application and the customer application and validates the deployment.

### TECHNICAL FIELD

The subject matter disclosed herein generally relates to automated deployment of integrated applications to customer infrastructure.

### BACKGROUND

Two cloud native applications executing in different environments coordinate using defined interfaces. Integration of the applications requires substantial time, expertise, and testing to ensure proper functioning.

### BRIEF DESCRIPTION OF THE DRAWINGS

FIG. 1 shows a network diagram illustrating an example network environment suitable for providing automatic deployment of integrated applications.

FIG. 2 shows a block diagram of components of a deployment system and tenant infrastructure, for automatic deployment of applications to the tenant infrastructure that are integrated with a central cloud deployment, according to some example embodiments.

FIG. 3 is a block diagram of components of a deployment orchestrator of FIG. 2, according to some example embodiments.

FIG. 4 shows a flowchart illustrating a method of automatic deployment of integrated applications.

FIG. 5 shows a block diagram showing one example of a software architecture for a computing device.

FIG. 6 shows a block diagram of a machine in the example form of a computer system within which instructions may be executed for causing the machine to perform any one or more of the methodologies discussed herein.

### DETAILED DESCRIPTION

Example methods and systems are directed to automatic deployment of integrated applications to customer infrastructure. An integrated application is an application in which a first application executes in a first cloud environment (e.g., a cloud environment of the application provider) and a second application executes in a second cloud environment (e.g., a cloud environment of a customer). By way of example and not limitation, the first cloud environment will be described as being the cloud environment of the application provider and the second cloud environment will be described as being the cloud environment of the customer. The first application may be referred to as a “host application.” The second application may be referred to as a “customer application.” The first application and the second application work together to form an “integrated application.”

One method of deployment is for the application provider to provide a copy of the customer application to an administrator of the customer, along with instructions for installation and configuration. However, the installation and configuration may be complex and difficult for an administrator that lacks experience with the particular application being deployed.

Another method of deployment is for the customer to provide access to the customer infrastructure to an administrator of the application provider. The application provider is then able to control the deployment process and troubleshoot any problems with integration. However, the access to the customer infrastructure may be abused. For example, login credentials may be stored on a system of the application provider. In a later security breach, a malicious actor may gain access to the login credentials and use them to attack the customer infrastructure.

Using the systems and methods described herein, an application provider is enabled to deploy an integrated application to customer infrastructure while reducing or eliminating the security vulnerabilities that arise. A deployment orchestrator provides a user interface that may be embedded in the host application. Using the user interface, a customer administrator generates a role. The deployment orchestrator provides a role template for the role. The role template identifies the permissions needed for the deployment. As a result, the customer administrator can review the permissions in the role template and, if accepted, create a role that includes those permissions and no others. Accordingly, if a malicious actor accesses the customer infrastructure using the role, the malicious actor will not be able to perform any actions that are not covered by the permissions.

The role template may be dynamically generated and include an expiration time that is based on the time of generation (e.g., to last for twenty minutes, one hour, or another time period). As a result, the role will expire, limiting the duration of any related security vulnerability.

Using the role, a deployment orchestrator automatically deploys the customer application to the customer infrastructure. An integration module of the deployment orchestrator validates the deployment and integration of the host application and the customer application.

By use of the described systems and methods, the efficient and secure deployment of integrated applications to customer infrastructure is facilitated. By comparison with systems that do not use automated or service-provider based deployment, the level of effort by customers is reduced. By comparison with systems that involve provision of existing customer credentials to the service provider for deployment, security is improved. Accordingly, the described systems and methods improve the functioning of cloud infrastructure environments.

Other advantages that result from various described embodiments include avoiding the creation of a single account with permissions to access infrastructure of multiple customers; avoiding the receipt of customer secrets (e.g., usernames and passwords of existing accounts) by the service provider; avoiding the revocation, by customers, of deployments accounts; detecting any modification of the deployment role or the role template that it is based on, using hashing; reducing misuse of the role by limiting the IP addresses from which the role can be used to connect to the customer infrastructure; reducing misuse of the role by limiting the time period in which the role can be used to connect to the customer infrastructure; avoiding impersonation of one customer by another by using an additional external identifier to verify the customer; avoiding misuse of the external identifier by service provider personnel by storing only a hash of the external identifier and deleting the external identifier itself once it is provided to the customer; improved ease of use for the customer; and scalable to handle any complexity of deployment by modifying the role template.

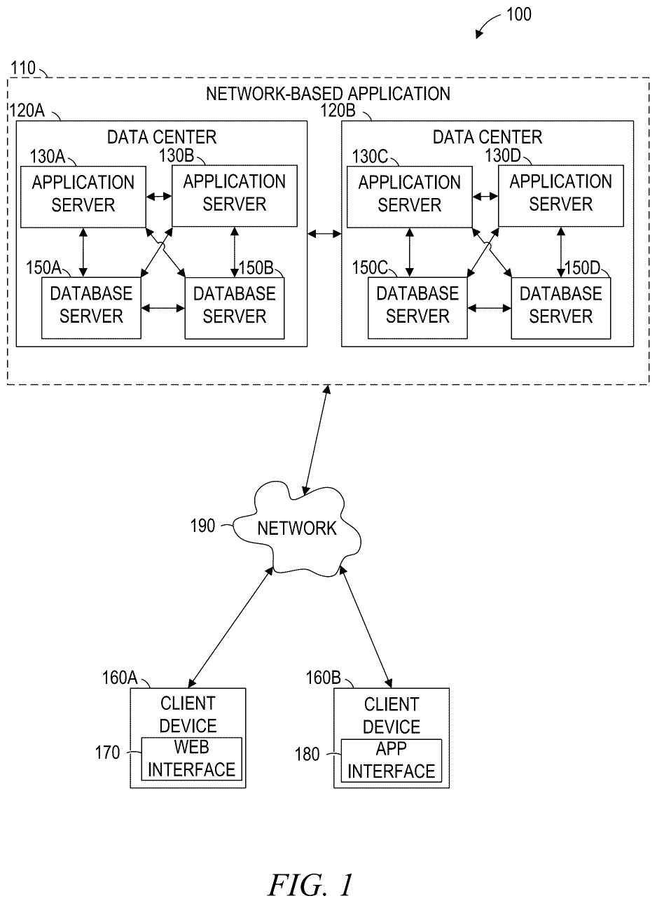

FIG. 1 shows a network diagram illustrating an example network environment 100 suitable for providing automatic deployment of integrated applications. The network environment 100 includes a network-based application 110, client devices 160A and 160B, and a network 190. The network-based application 110 is integrated across two data centers 120A and 120B. The data center 120A comprises application servers 130A and 130B in communication with database servers 150A and 150B. The data center 120B comprises application servers 130C and 130D in communication with database servers 150C and 150D. An application executing on the application servers 130A-130B may access data from the database servers 150A-150B.

Similarly, an application executing on the application servers 130C-130D may access data from the database servers 150C-150D. The letter suffixes of reference numbers may be omitted when doing so does not raise ambiguity. For example, the application servers 130A-130D may be referred to collectively as “application servers 130.” Similarly, when the specific one of the application servers 130A-130D is not of particular import, “application server 130” may be referenced.

The application executing in the data center 120A may communicate with the application executing in the data center 120B to form an integrated application. The integrated application may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The application servers 130 may communicate with the database servers 150 using a representational state transfer (REST) API, the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

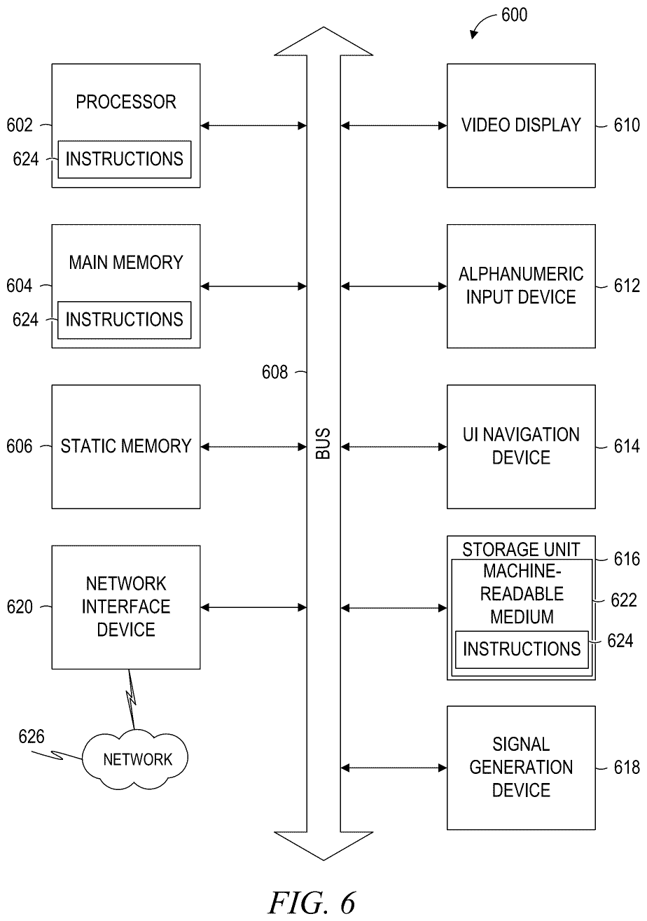

The application servers 130A-130D, the database servers 150A-150D, and the client devices 160A-160B may each be implemented in a computer system, in whole or in part, as described below with respect to FIG. 6. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130D, the database servers 150A-150D, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or a few of each element (e.g., four application servers 130A-130D, two client devices 160A and 160B, and the like), any number of each element is contemplated. For example, the application server 130A may be one of dozens or hundreds of active and standby servers and provide services to millions of client devices.

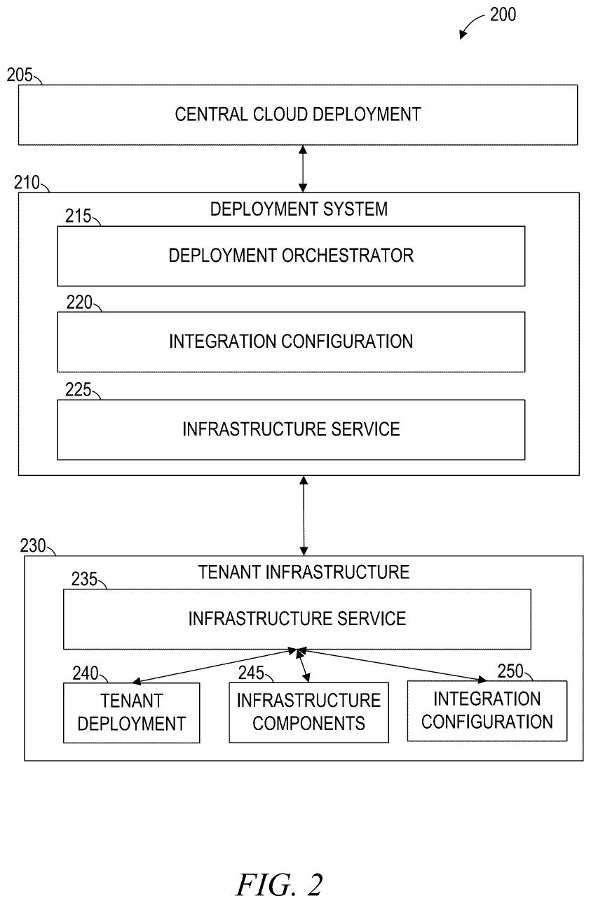

FIG. 2 shows a block diagram 200 of components of a deployment system 210 and tenant infrastructure 230, for automatic deployment of applications to the tenant infrastructure 230 that are integrated with a central cloud deployment 205, according to some example embodiments. The central cloud deployment 205 may be implemented as an application executing in the data center 120A of FIG. 1. The infrastructure service 225 may be part of the data center 120B of FIG. 1. The deployment system 210 may execute in the data center 120A or another computing environment.

The deployment system 210 includes a deployment orchestrator 215, an integration configuration 220, and an infrastructure service 225. The integration configuration 220 comprises information about the application being deployed from the deployment system 210 to the tenant infrastructure 230, such as the permissions that will be needed in the tenant infrastructure 230 to deploy the application.

The deployment orchestrator 215 communicates with an administrator of the tenant infrastructure 230 to orchestrate deployment of the application to the tenant infrastructure 230. For example, the deployment orchestrator 215 may provide a role template for use in generating a role in the tenant infrastructure 230 with permissions for deploying the application. After the role is created, credentials for the role are provided to the deployment orchestrator 215. The deployment orchestrator 215 uses the role to deploy the application.

The tenant infrastructure 230 includes an infrastructure service 235, a tenant deployment 240, infrastructure components 245, and integration configuration 250. The deployment orchestrator 215 uses the infrastructure service 235 to deploy the application as the tenant deployment 240. The tenant deployment 240 makes use of infrastructure components 245 (e.g., hardware components such as processors, memory, and networking resources; software components such as services; or both) to implement the application. The tenant deployment 240 interacts with the central cloud deployment 205 according to the integration configuration 250 (e.g., using stored uniform resource locators (URLs), access credentials, and the like).

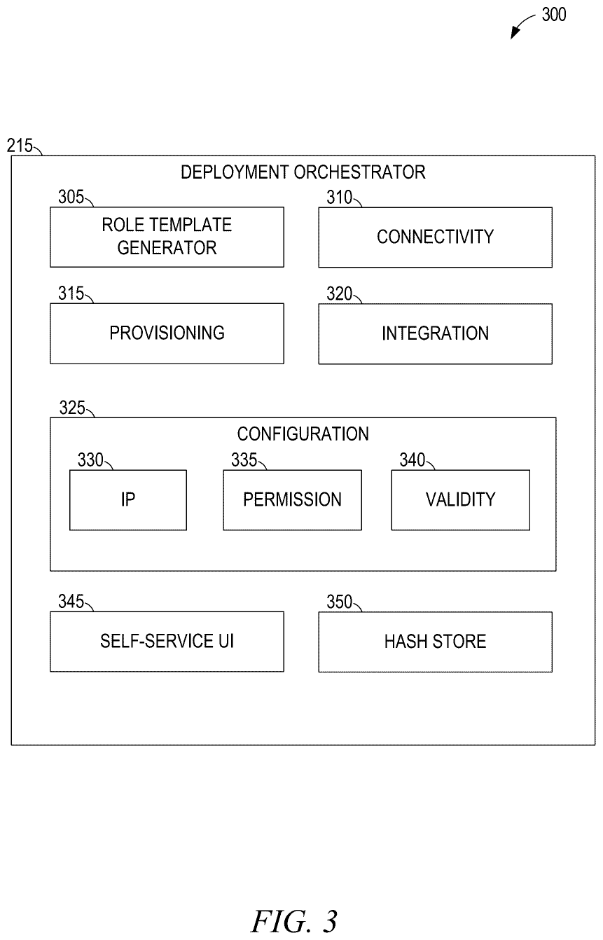

FIG. 3 is a block diagram 300 of components of the deployment orchestrator 215 of FIG. 2, according to some example embodiments. The deployment orchestrator 215 includes a role template generator 305, a connectivity module 310, a provisioning module 315, an integration module 320, a configuration module 325, and a hash store 350. The deployment orchestrator 215 provides a self-service UI 345. The configuration module 325 includes an internet protocol (IP) configuration 330, a permission configuration 335, and a validity module 340. The modules of FIG. 3 are configured to communicate with each other (e.g., using a bus or a switch).

The IP configuration 330 determines an IP address to be used to access the deployed application. The role template generator 305 generates a template for a role that will have permissions for deploying the application to customer infrastructure. The hash store 350 may store a hash of the role template, a hash of the external identifier, or any suitable combination thereof.

Using the self-service UI 345, a customer administrator can generate a role based on the role template. The customer administrator provides the role via the self-service UI 345 and triggers the provisioning module 315. The provisioning module 315 uses the connectivity module 310 to generate a short-lived token based on the role. The connectivity module 310 communicates with the infrastructure service 235 of the tenant infrastructure 230 (both of FIG. 2).

The integration module 320 uses the infrastructure services 225 and 235 to enable bi-directional communication between the central cloud deployment 205 and the tenant deployment 240. Thus, after deployment of the application to the tenant infrastructure 230, the separate components of the integrated application are enabled to communicate and work together.

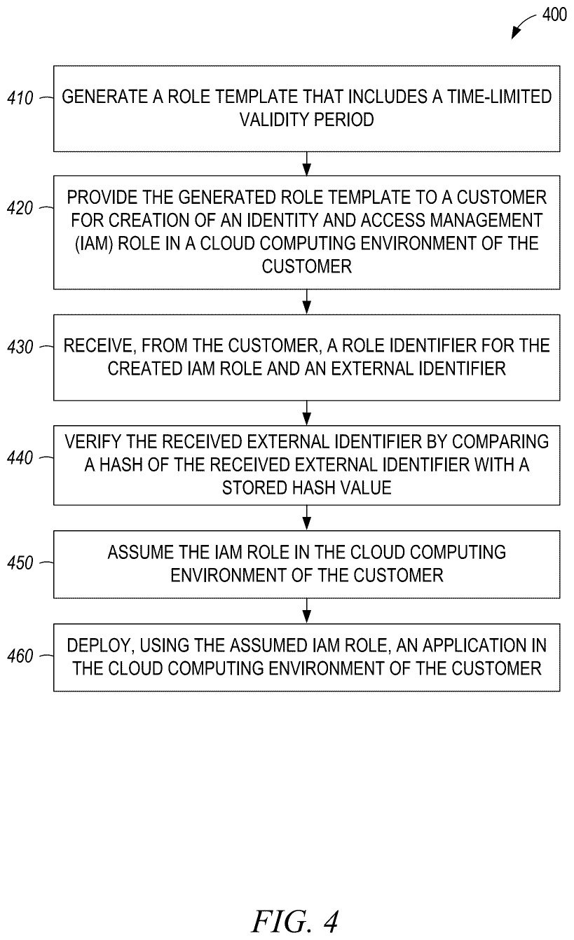

FIG. 4 shows a flowchart illustrating a method 400 of automatic deployment of integrated applications. The method 400 includes operations 410, 420, 430, 440, 450, and 460. By way of example and not limitation, the method 400 is described as being performed by the deployment system 210 of FIG. 2 and the components of the deployment orchestrator 215 of FIGS. 2-3 in the computing environment 100 of FIG. 1.

In operation 410, the role template generator 305 generates a role template that includes a time-limited validity period. The time-limited validity period may include an expiration date/time that is a predefined amount of time after the time at which the role template is generated. For example, a role template generated at 12:00 PM on Jan. 1, 2024 may expire at 12:20 PM the same day, where the predefined amount of time is twenty minutes. Operation 410 may be performed in response to a user interaction with the self-service UI 345. The generated role template may include an external identifier that is unique among all role templates generated by the deployment system 210. The hash store 350 may store a hash of the role template, a hash of the external identifier, or any suitable combination thereof.

In various example embodiments, the role template includes an external identifier and additional or different conditions limiting the validity and use of an Identity and Access Management (IAM) role. An IAM role is a collection of permissions that allows a user, group, or account to perform specific actions on a cloud resource. An external identifier is a random string that uniquely distinguishes customer infrastructures in the generated IAM role. The terms IAM role and external identifier are used by Amazon Web Services (AWS). Other cloud providers may have other terms, but the concept is the same. For clarity, the terms IAM role and external identifier will be used herein as generic terms for all cloud providers.

The role template may include a trust relationship that specifies a trusted entity, such as a user. A role created based on the role template may be assumable only by the trusted entity, preventing other entities from using the role to access the customer's computing environment. The role template may include a set of permissions defining actions allowed for deploying the application. A role created based on the role template may perform the defined actions while being prohibited from performing other actions.

The role template generator 305, in operation 420, provides the generated role template to a customer for creation of an Identity and Access Management (IAM) role in a cloud computing environment of the customer. The generated role template may be downloaded as a file via a web browser (e.g., the web interface 170 of FIG. 1). The customer may use the role template to create an IAM role in the cloud computing environment of the customer (e.g., the tenant infrastructure 230, utilizing components of the data center 120B of FIG. 1).

In operation 430, the provisioning module 315 receives, from the customer, a role identifier for the created IAM role and an external identifier. The external identifier uniquely identifies the customer to the deployment orchestrator 215 and is independent of the IAM role used to connect to the cloud computing environment of the customer. The external identifier may be generated by the deployment orchestrator 215 and provided to the customer before the method 400 begins. Alternatively, the external identifier may be generated during operation 410 and provided to the customer in operation 420. A hash of the external identifier is stored in the hash store 350. To prevent malicious usage of external identifier by internal actors (employees) of the host application, only the hash value of the external identifier is stored instead of exposing them in the backend.

The created IAM role may include conditions limiting access to requests originating from specified Internet Protocol (IP) addresses. For example, the specified IP addresses may be IP addresses associated with a primary application in a second cloud computing environment, such as the deployment system 210 operating in a different data center than the cloud computing environment of the customer. For further security, the created IAM role may include conditions limiting access to requests made within the time-limited validity period.

The provisioning module 315 verifies the received external identifier by comparing a hash of the received external identifier with a stored hash value (operation 440). The stored hash value may be accessed from the hash store 350. If the hash values do not match, the method 400 is aborted. Otherwise, the verification is successful and the method 400 continues with operation 450. Thus, the performance of operation 450 may be in response to a successful verification of the received external identifier.

The provisioning module 315 may also receive, from the customer, a copy of the role template used to create the role for which the role identifier was received in operation 430. This allows the provisioning module 315 to verify the integrity of the received role template by comparing a hash of the received role template with the stored hash of the generated role template.

In operation 450, the provisioning module 315 assumes the IAM role in the cloud computing environment of the customer. The cloud computing environment of the customer allows the deployment system 210 access according to the permissions of the role. The permissions of the role were defined by the role template provided in operation 420. Thus, the provisioning module 315 is enabled to perform the needed tasks for deployment.

The provisioning module 315, using the assumed IAM role, deploys an application in the cloud computing environment of the customer (operation 460). The deployment of the application may include copying files to a file system, adding data to a database, opening network ports, or any suitable combination thereof. The deployed application is configured to communicate with an application in the central cloud deployment 205, enabling the cloud-based integrated application to interoperate. Thus, the method 400 may further comprise establishing an integration between the deployed application in the cloud computing environment of the customer and a primary application in a second cloud computing environment.

Accordingly, by use of the method 400, the deployment system 210 is enabled to control deployment of software to the cloud computing environment of a customer without having unlimited access to the cloud computing environment of the customer. The limited access provided by the IAM role is, additionally, time-limited. This ensures that if a malicious actor gains access to the IAM role at a later time, the customer's cloud computing environment will not be compromised. By comparison with customer-controlled deployments, the deployment is less error-prone. By comparison with service provider-controlled deployments using unfettered access, the deployment is more secure.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one hardware processor; and a computer-readable medium storing instructions that, when executed by the at least one hardware processor, cause the at least one hardware processor to perform operations comprising: generating a role template that includes, a time-limited validity period; providing the generated role template to a customer for creation of an Identity and Access Management (IAM) role in a cloud computing environment of the customer; receiving, from the customer, a role identifier for the created IAM role and an external identifier; verifying the received external identifier by comparing a hash of the received external identifier with a stored hash value; assuming the IAM role in the cloud computing environment of the customer; and deploying, using the assumed IAM role, an application in the cloud computing environment of the customer.

In Example 2, the subject matter of Example 1, wherein the assuming of the IAM role in the cloud computing environment of the customer is performed in response to a successful verification of the received external identifier.

In Example 3, the subject matter of Examples 1-2, wherein the operations further comprise establishing an integration between the deployed application in the cloud computing environment of the customer and a primary application in a second cloud computing environment.

In Example 4, the subject matter of Examples 1-3, wherein the IAM role includes conditions limiting access to requests originating from specified Internet Protocol (IP) addresses associated with a primary application in a second cloud computing environment.

In Example 5, the subject matter of Examples 1-4, wherein the IAM role includes conditions limiting access to requests made within the time-limited validity period.

In Example 6, the subject matter of Examples 1-5, wherein the time-limited validity period is set to expire within a predetermined period of time after the generating of the role template.

In Example 7, the subject matter of Examples 1-6, wherein the role template includes a trust relationship specifying a trusted entity.

In Example 8, the subject matter of Examples 1-7, wherein the role template includes a set of permissions defining actions allowed for deploying the application.

In Example 9, the subject matter of Examples 1-8, wherein the role template includes conditions limiting the validity and use of the IAM role.

In Example 10, the subject matter of Examples 1-9, wherein the operations further comprise: storing a hash of the generated role template; receiving a copy of the role template used by the customer to create the IAM role; and verifying the integrity of the received role template by comparing a hash of the received role template with the stored hash of the generated role template.

Example 11 is a non-transitory computer-readable medium that stores instructions that, when executed by one or more processors, cause the one or more processors to perform operations comprising: generating a role template that includes, a time-limited validity period; providing the generated role template to a customer for creation of an Identity and Access Management (IAM) role in a cloud computing environment of the customer; receiving, from the customer, a role identifier for the created IAM role and an external identifier; verifying the received external identifier by comparing a hash of the received external identifier with a stored hash value; assuming the IAM role in the cloud computing environment of the customer; and deploying, using the assumed IAM role, an application in the cloud computing environment of the customer.

In Example 12, the subject matter of Example 11, wherein the assuming of the IAM role in the cloud computing environment of the customer is performed in response to a successful verification of the received external identifier.

In Example 13, the subject matter of Examples 11-12, wherein the operations further comprise establishing an integration between the deployed application in the cloud computing environment of the customer and a primary application in a second cloud computing environment.

In Example 14, the subject matter of Examples 11-13, wherein the IAM role includes conditions limiting access to requests originating from specified Internet Protocol (IP) addresses associated with a primary application in a second cloud computing environment.

In Example 15, the subject matter of Examples 11-14, wherein the JAM role includes conditions limiting access to requests made within the time-limited validity period.

In Example 16, the subject matter of Examples 11-15, wherein the time-limited validity period is set to expire within a predetermined period of time after the generating of the role template.

In Example 17, the subject matter of Examples 11-16, wherein the role template includes a trust relationship specifying a trusted entity.

Example 18 is a method comprising: generating, by one or more processors, a role template that includes, a time-limited validity period; providing the generated role template to a customer for creation of an Identity and Access Management (IAM) role in a cloud computing environment of the customer; receiving, from the customer, a role identifier for the created IAM role and an external identifier; verifying the received external identifier by comparing a hash of the received external identifier with a stored hash value; assuming the IAM role in the cloud computing environment of the customer; and deploying, using the assumed IAM role, an application in the cloud computing environment of the customer.

In Example 19, the subject matter of Example 18, wherein the assuming of the IAM role in the cloud computing environment of the customer is performed in response to a successful verification of the received external identifier.

In Example 20, the subject matter of Examples 18-19 includes establishing an integration between the deployed application in the cloud computing environment of the customer and a primary application in a second cloud computing environment.

Example 21 is an apparatus comprising means to implement any of Examples 1-20.

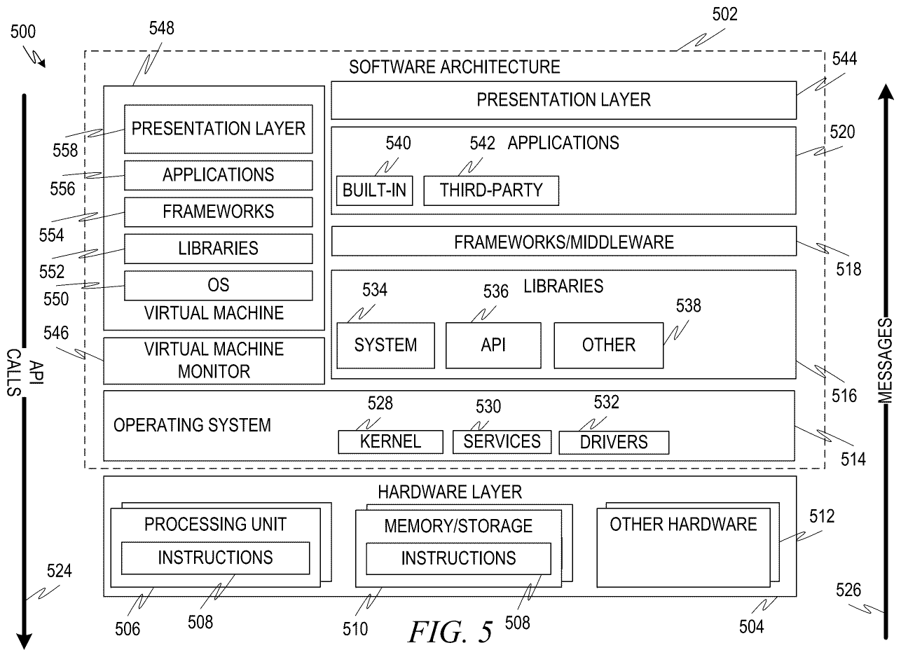

FIG. 5 shows a block diagram 500 showing one example of a software architecture 502 for a computing device. The software architecture 502 may be used in conjunction with various hardware architectures, for example, as described herein. FIG. 5 is merely a non-limiting example of a software architecture, and many other architectures may be implemented to facilitate the functionality described herein. A representative hardware layer 504 is illustrated and can represent, for example, any of the above referenced computing devices. In some examples, the hardware layer 504 may be implemented according to the architecture of the computer system of FIG. 5.

The representative hardware layer 504 comprises one or more processing units 506 having associated executable instructions 508. Executable instructions 508 represent the executable instructions of the software architecture 502, including implementation of the methods, modules, subsystems, and components, and so forth described herein and may also include memory and/or storage modules 510, which also have executable instructions 508. Hardware layer 504 may also comprise other hardware as indicated by other hardware 512 which represents any other hardware of the hardware layer 504, such as the other hardware illustrated as part of the software architecture 502.

In the example architecture of FIG. 5, the software architecture 502 may be conceptualized as a stack of layers where each layer provides particular functionality. For example, the software architecture 502 may include layers such as an operating system 514, libraries 516, frameworks/middleware 518, applications 520, and presentation layer 544.

Operationally, the applications 520 and/or other components within the layers may invoke application programming interface (API) calls 524 through the software stack and access a response, returned values, and so forth illustrated as messages 526 in response to the API calls 524. The layers illustrated are representative in nature and not all software architectures have all layers. For example, some mobile or special purpose operating systems may not provide a frameworks/middleware 518 layer, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. In some examples, the services 530 include an interrupt service. The interrupt service may detect the receipt of an interrupt and, in response, cause the software architecture 502 to pause its current processing and execute an interrupt service routine (ISR) when an interrupt is accessed.

The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 516 may include system libraries 534 (e.g., C standard library) that may provide functions such as memory allocation functions, string manipulation functions, mathematic functions, and the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 516 may also include a wide variety of other libraries 538 to provide many other APIs to the applications 520 and other software components/modules.

The frameworks/middleware 518 may provide a higher-level common infrastructure that may be utilized by the applications 520 and/or other software components/modules. For example, the frameworks/middleware 518 may provide various graphic user interface (GUI) functions, high-level resource management, high-level location services, and so forth. The frameworks/middleware 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any of the built-in applications 540 as well as a broad assortment of other applications. In a specific example, the third-party application 542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 542 may invoke the API calls 524 provided by the mobile operating system such as operating system 514 to facilitate functionality described herein.

The applications 520 may utilize built-in operating system functions (e.g., kernel 528, services 530 and/or drivers 532), libraries (e.g., system libraries 534, API libraries 536, and other libraries 538), and frameworks/middleware 518 to create user interfaces to interact with users of the system. Alternatively, or additionally, in some systems, interactions with a user may occur through a presentation layer, such as presentation layer 544. In these systems, the application/module “logic” can be separated from the aspects of the application/module that interact with a user.

Some software architectures utilize virtual machines. In the example of FIG. 5, this is illustrated by virtual machine 548. A virtual machine creates a software environment where applications/modules can execute as if they were executing on a hardware computing device. A virtual machine is hosted by a host operating system (operating system 514) and typically, although not always, has a virtual machine monitor 546, which manages the operation of the virtual machine 548 as well as the interface with the host operating system (i.e., operating system 514). A software architecture executes within the virtual machine 548 such as an operating system 550, libraries 552, frameworks/middleware 554, applications 556 and/or presentation layer 558. These layers of software architecture executing within the virtual machine 548 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 6 shows a block diagram of a machine in the example form of a computer system 600 within which instructions 624 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube [CRT]). The computer system 600 also includes an alphanumeric input device 612 (e.g., a keyboard or a touch-sensitive display screen), a user interface (UI) navigation (or cursor control) device 614 (e.g., a mouse), a storage unit 616, a signal generation device 618 (e.g., a speaker), and a network interface device 620.

### Machine-Readable Medium

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting a machine-readable medium 622.

While the machine-readable medium 622 is shown in FIG. 6 to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with the instructions 624. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 624 may further be transmitted or received over a communications network 626 using a transmission medium. The instructions 624 may be transmitted using the network interface device 620 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
at least one hardware processor; and
a computer-readable medium storing instructions that, when executed by the at least one hardware processor, cause the at least one hardware processor to perform operations comprising:
generating a role template that includes a time-limited validity period;
providing the generated role template to a customer for creation of an Identity and Access Management (IAM) role in a cloud computing environment of the customer;
receiving, from the customer, a role identifier for the created IAM role and an external identifier;
verifying the received external identifier by comparing a hash of the received external identifier with a stored hash value;
assuming the IAM role in the cloud computing environment of the customer; and
deploying, using the assumed IAM role, an application in the cloud computing environment of the customer.

2. The system of claim 1, wherein the assuming of the IAM role in the cloud computing environment of the customer is performed in response to a successful verification of the received external identifier.

3. The system of claim 1, wherein the operations further comprise establishing an integration between the deployed application in the cloud computing environment of the customer and a primary application in a second cloud computing environment.

4. The system of claim 1, wherein the IAM role includes conditions limiting access to requests originating from specified Internet Protocol (IP) addresses associated with a primary application in a second cloud computing environment.

5. The system of claim 1, wherein the IAM role includes conditions limiting access to requests made within the time-limited validity period.

6. The system of claim 1, wherein the time-limited validity period is set to expire within a predetermined period of time after the generating of the role template.

7. The system of claim 1, wherein the role template includes a trust relationship specifying a trusted entity.

8. The system of claim 1, wherein the role template includes a set of permissions defining actions allowed for deploying the application.

9. The system of claim 1, wherein the role template includes conditions limiting the validity and use of the IAM role.

10. The system of claim 1, wherein the operations further comprise:
storing a hash of the generated role template;
receiving a copy of the role template used by the customer to create the IAM role; and
verifying the integrity of the received role template by comparing a hash of the received role template with the stored hash of the generated role template.

11. A non-transitory computer-readable medium that stores instructions that, when executed by one or more processors, cause the one or more processors to perform operations comprising:
generating a role template that includes a time-limited validity period;
providing the generated role template to a customer for creation of an Identity and Access Management (IAM) role in a cloud computing environment of the customer;
receiving, from the customer, a role identifier for the created IAM role and an external identifier;
verifying the received external identifier by comparing a hash of the received external identifier with a stored hash value;
assuming the IAM role in the cloud computing environment of the customer; and
deploying, using the assumed IAM role, an application in the cloud computing environment of the customer.

12. The non-transitory computer-readable medium of claim 11, wherein the assuming of the IAM role in the cloud computing environment of the customer is performed in response to a successful verification of the received external identifier.

13. The non-transitory computer-readable medium of claim 11, wherein the operations further comprise establishing an integration between the deployed application in the cloud computing environment of the customer and a primary application in a second cloud computing environment.

14. The non-transitory computer-readable medium of claim 11, wherein the IAM role includes conditions limiting access to requests originating from specified Internet Protocol (IP) addresses associated with a primary application in a second cloud computing environment.

15. The non-transitory computer-readable medium of claim 11, wherein the IAM role includes conditions limiting access to requests made within the time-limited validity period.

16. The non-transitory computer-readable medium of claim 11, wherein the time-limited validity period is set to expire within a predetermined period of time after the generating of the role template.

17. The non-transitory computer-readable medium of claim 11, wherein the role template includes a trust relationship specifying a trusted entity.

18. A method comprising:
generating, by one or more processors, a role template that includes a time-limited validity period;
providing the generated role template to a customer for creation of an Identity and Access Management (IAM) role in a cloud computing environment of the customer;
receiving, from the customer, a role identifier for the created IAM role and an external identifier;
verifying the received external identifier by comparing a hash of the received external identifier with a stored hash value;
assuming the IAM role in the cloud computing environment of the customer; and
deploying, using the assumed IAM role, an application in the cloud computing environment of the customer.

19. The method of claim 18, wherein the assuming of the IAM role in the cloud computing environment of the customer is performed in response to a successful verification of the received external identifier.

20. The method of claim 18, further comprising establishing an integration between the deployed application in the cloud computing environment of the customer and a primary application in a second cloud computing environment.
